(19) United States
(12) Patent Application Publication
(10) Pub. No.: US 2016/0132972 A1
(43) Pub. Date: May 12, 2016

(54) SOCIAL MEDIA PLATFORM

(71) Applicant: Stuart M. Fetzer, Sandy, UT (US)

(72) Inventor: Stuart M. Fetzer, Sandy, UT (US)

(21) Appl. No.: 14/536,088

(22) Filed: Nov. 7, 2014

(51) Int. Cl. G06Q 50/00; H04L 12/58; G06Q 10/10

(52) U.S. Cl. CPC G06Q 50/01; G06Q 10/10; H04L 51/32

(57) ABSTRACT

A method for a social media platform is described. In one embodiment, data that includes information associated with social media content is identified. A question is presented via a user interface. The question is based at least in part on one or more of the identified data, data provided by a moderator, and data gathered and sorted by category. A response to the user is provided based at least in part on receiving a user input or receiving no user input.

### BACKGROUND

Advancements in media delivery systems and data-related technologies continue to increase at a rapid pace. Increasing demand for accessible data has influenced the advances made to data-related technologies. Computer systems have increasingly become an integral part of data creation, data usage, and data storage. Computer systems may be used to carry out several data-related functions. The widespread access to data has been accelerated by the increased use of computer networks, including the Internet and cloud networking.

Many homes and businesses use one or more computer networks to generate, deliver, and receive data and information between the various computers connected to computer networks. Users of computer technologies continue to demand increased access to information and an increase in the efficiency of these technologies. Improving the efficiency of computer technologies is desirable to those who use and rely on computers.

With the widespread use of computers and mobile devices has come an increased presence of and continued advancements in social media services. For example, advancements in mobile devices allow users to connect with other users on social media services from anywhere in the world. Nevertheless, benefits may be realized by providing systems and methods for improving social media systems.

### SUMMARY

According to at least one embodiment, a method for a social media platform is described. In one embodiment, data that includes information associated with social media content is identified. A question may be presented via a user interface. The question may be based at least in part on one or more of the identified data, data provided by a moderator, or data gathered and sorted by category. A response to the user may be provided based at least in part on receiving a user input or receiving no user input.

In some embodiments, identifying the data may include randomly collecting data from one or more of the user's connections. Identifying the data may include using an algorithm to collect data from one or more of the user's connections. The data may include identifying information specific to one of the user's social media connections. The data may include at least one of an event, a status update, an image, and a photograph.

In some embodiments, a question may include a plurality of answer choices. The plurality of choices may include one correct answer. The method may include correlating the received input with the data and providing the response may include providing negative and/or positive feedback based at least in part on the received input. Providing the response may be based at least in part on a measured response time of the user. The response may include at least one of a coupon, a voucher, a discount, a credit, and a product.

In some embodiments, presenting the question may include presenting the question to a group of two or more social network users. The method may include providing at least one response to each user in the group of social network users based at least in part on receiving a user input or receiving no user input from each user of the group of social network of users.

A computing device configured for a social media platform is also described. The computing device may include a processor and memory in electronic communication with the processor. The memory may store computer executable instructions that when executed by the processor cause the processor to perform the steps of identifying data that includes information associated with social media content, presenting, via a user interface, a question, and providing a response to the user based at least in part on receiving a user input or receiving no user input. In some cases, the question may be based at least in part on one or more of the identified data, data provided by a moderator, or data gathered and sorted by category.

A non-transitory computer-readable storage medium storing computer executable instructions is also described. When the instructions are executed by a processor, the execution of the instructions may cause the processor to perform the steps of identifying data that includes information associated with social media content, presenting, via a user interface, a question, and providing a response to the user based at least in part on receiving a user input or receiving no user input. In some cases, the question may be based at least in part on one or more of the identified data, data provided by a moderator, or data gathered and sorted by category.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram illustrating one embodiment of an environment in which the present systems and methods may be implemented;

FIG. 2 is a block diagram illustrating one example of a social media module;

FIG. 3A is a block diagram illustrating one example of a mobile device configured to interface with a social media platform;

FIG. 3B is a block diagram illustrating another example of the mobile device configured to interface with a social media platform;

FIG. 3C is a block diagram illustrating another example of the mobile device configured to interface with a social media platform;

FIG. 3D is a block diagram illustrating another example of the mobile device configured to interface with a social media platform;

FIG. 3E is a block diagram illustrating another example of the mobile device configured to interface with a social media platform;

FIG. 4 is a block diagram illustrating one example of an environment for a social media platform;

FIG. 5 is a block diagram illustrating one example of an environment for a social media platform;

FIG. 6 is a block diagram illustrating one example of an environment for a social media platform;

FIG. 7 is a block diagram illustrating one example of an environment for a social media platform;

FIG. 8 is a block diagram illustrating one example of an environment for a social media platform;

FIG. 9 is a block diagram illustrating one example of an environment for a social media platform;

FIG. 10 is a block diagram illustrating one example of an environment for a social media platform;

FIG. 11 is a block diagram illustrating one example of an environment for a social media platform;

FIG. 12 is a flow diagram illustrating one embodiment of a method for a social media platform;

FIG. 13 is a flow diagram illustrating one embodiment of a method for a social media platform; and

FIG. 14 depicts a block diagram of a computer system suitable for implementing the present systems and methods.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

The systems and methods described herein relate to social media systems. The systems and methods described herein relate to a social media platform in relation to one or more social media services. Some embodiments of the systems and methods described herein relate to a social media platform in relation to connections on social media services. Specifically, the following relates to improving users social media experience through an interactive query platform configured to increase advertising efficacy while enabling social media users to get to know each other better

In one example, a user may use one or more social media services such as FACEBOOK®, TWITTER®, LINKED-IN®, GOOGLE+®, PINTEREST®, INSTAGRAM®, and the like, in order to make connections and share content with other users. The user of one or more such social media services, however, may only know relatively well a small percentage of his or her social media connections. Thus, the present systems and methods may enable the user to get to know more about his or her social media connections. Additionally, or alternatively, the present systems and methods may enable a user to get to know more about an organization such as a company, a corporation, an agency, and the like. For example, an employee may get to know more about the company he or she works for via the present systems and methods. Likewise, a fan or follower of an organization may learn more about the organization by the present systems and methods, category, etc.

There are a number of challenges facing social media users, advertisers, and companies attempting to reach those users through social media services. Users of social media may have a relatively large number of social media connections. For example, a user may be linked to, following, and friends of hundreds of other social media users. Thus, while a social media user may be connected to hundreds of other users, it is more than likely that the user knows very little about the majority of their connections.

Advertisers and companies attempting to reach social media users face a number of obstacles. If an advertiser or company wants to reach social media users the advertiser or company is bound by the marketing options that a particular social media service provides. For example, even though a company may have hundreds, thousands, or even millions of followers on a social media service, the social media service may impose a policy that the company must pay to reach these followers. Thus, when the company makes a post on the social media service, only a small percentage of the overall number of followers may see this post. To reach more users, the company may have to pay the social media service a fixed price for every additional 1000 followers reached. Moreover, a majority of social media users may recognize advertisements placed in a social media feed and skip over the advertisement without paying any attention to the content in the advertisement.

To solve these problems for social media users, advertisers, and companies, the present systems and methods may employ an interactive platform that queries a social media user about their connections in the form of an interactive game. In one embodiment, the game may be presented in a question and answer format. In some embodiments, a user may receive a question pertaining to one or more of his or her connections. These connections have previously produced various data (e.g., posts, tweets, images, updates, shares, likes, etc.). The questions may be direct questions such as “Who generated the following content?” or may be implied by the structure of the content displayed to the user. For example, the system may display content from a social media contact and then state “Make a selection” and display two or more options of possible social media contacts that generated the displayed content.

The platform gathers information produced by the connections and delivers a portion of this information to the receiving user or users in the form of a question. The receiving user answers the question based on the answer choices produced by the system. In some instances, the receiving user may have a limited time to answer the question (e.g., 30 seconds to answer the question once displayed). After the user answers, the platform may provide feedback to the receiving user based on his/her answer to the one or more questions.

In some embodiments, the receiving user may be enabled to create questions based on information about the connections and provide these questions to other receiving users. In some embodiments, the system may enable multiple receiving users to compete against each other by answering questions related to shared or unshared connections. In some embodiments, an advertiser or a receiving user may initiate a competition for one or more receiving users, such as sending questions to the receiving users and providing an incentive to the receiving user who correctly answers a certain number of questions in the shortest time. In some embodiments, companies may create a question relating to one or more users, company products, or any other related topics. Advertisers and companies may provide an incentive based on one or more users' answers to the questions. In some embodiments, the receiving user may be connected to an employer, corporation, business, or related entity. The employer may create questions, notifications, or incentive offers using the platform and send these to the receiving user (e.g., employee, affiliate, or co-sponsor). Based on one or more receiving users' responses, the employer may collect relevant information, provide feedback, and/or other incentives to the one or more receiving users

Some embodiments relate to systems, method, and related devices for enhancing at least one user's social media experience. Currently, most social media users are “connected” to many other users. However, even connected users may not know each other well and may only have an ancillary or a tangential relationship.

In some embodiments, a user may be a member of a social network (e.g., TWITTER®, FACEBOOK®, INSTAGRAM®, LINKED-IN®, PINTEREST®, etc.) and may have various connections to members of the same social media network. Thus, the system may be adapted to or configured for gathering data related to the user and/or the user's connections. Additionally, or alternatively, connections may refer to contacts other than social media contacts. For example, connections may include an intranet or internal network of associates, colleagues, employees, clients, vendors, customers, etc. Thus, the system may be configured to gather data related to a user's contacts from an internal network of associates, etc. This data may include personal, identifying social media posts or updates, photographs, images, or any other data related to the members. The data may be processed in one or more ways. The system may send configured data to a receiving user and present a question to the receiving user. The question may be related to at least one of the receiving user's social media connections. For example, the question may include, “Which of the following people went to Europe last week?” or “Which of the following people enjoys skiing?” and so forth. As another example, the system may select a portion or subset of the available information for use in the question. The system may capture a portion of a connection's photograph and then ask the receiving user, “Whose photo is this?” or “Who is in this photo?” etc.

The user may be presented with multiple potential answers to choose from. In some embodiments, only one correct answer exists. In other embodiments, more than one correct answer may exist. The receiving user may answer the question through a user interface. The system correlates the answer with the data of the social media connections. In some embodiments, the system provides positive and/or negative feedback to the user based on the correlation. In some embodiments, the receiving user may have a designated amount of time to answer the question. In some embodiments, the system provides feedback to the receiving user about his/her progress.

In some embodiments, the system identifying the data includes randomly collected data from one or more of the receiving user's social media connections. Identifying the data may include using an algorithm to collect data from one or more of the user's connections. This algorithm may be based on qualitative, quantitative, or other relationships or data. In some cases, identified data includes identifying information of one of the receiving user's social media connections. This identifying information may include the connection's name, login name, network name, image, personal or other specific information.

In some embodiments, multiple receiving users may answer similar or identical questions. In some cases, the multiple receiving users may answer questions unique to their social networks and/or social network connections. In some cases, the system may enable these multiple users to answer simultaneously. Additionally, or alternatively, the system may enable users to answer and/or play a related game at varying times. For example, a first user may play a game on a certain day and subsequently, on the same day or a different day, a second user may play a game related to that of the first user. In some cases, the system may be configured for competitive play so that multiple user's may compete against each other. Based on this competition, certain feedback and incentives may be sent to the receiving users. In some embodiments, the receiving users may receive multiple questions one after another and one receiving user may “win” after correctly answering a designated number of questions. In some cases, the user may win by answering the most correct answers in the fastest time. During the competition, a receiving user who has answered some number of questions incorrectly may request additional questions. Such a request may require payment of a fee based on providing money, credits, information, watching an advertisement, etc. In some embodiments, the receiving user that correctly answers some number of questions before the other “wins.” As explained above, two users may compete without playing at the same time. The user that answers the most questions correctly wins the competition. In some cases, even if the players do not play simultaneously, the time each user takes to answer the questions may be recorded and this timing information may be used to determine a winner.

In some embodiments, a business or merchant may create questions that are sent to receiving users. The group of receiving users that may receive the merchant's questions may be based on the receiving users' social media profiles, connections, preferences, personal, or other information. For example, if a receiving user has indicated a preference for COCA-COLA® the user may receive a question from an advertiser or the company (i.e., directly from COCA-COLA®), based on this preference. Questions may include one or more right answer and one or more wrong answers so the receiving user can choose. Some questions may be posed simultaneously by merchants to multiple receiving users.

In some embodiments, the receiving user who correctly answers the question before others will be awarded an incentive. Merchant incentives may include coupons, discounts, vouchers, products. As part of the merchant questions, the system and in some cases the merchant, may collect market data and perform calculations about receiving users, receiving users' social media connections, predicted target populations before, during, and/or after the merchant's question, monetary gains, etc.

In some embodiments, the system may enable a company to send questions or other information to receiver employees, affiliates, partners, etc. The questions or other information may include training, announcement, products, specifications, scheduling, or any other related information. In some embodiments, the company may be able to receive responses and feedback from one or more receivers. The company may also make a competition between one or more receivers or receiver groups.

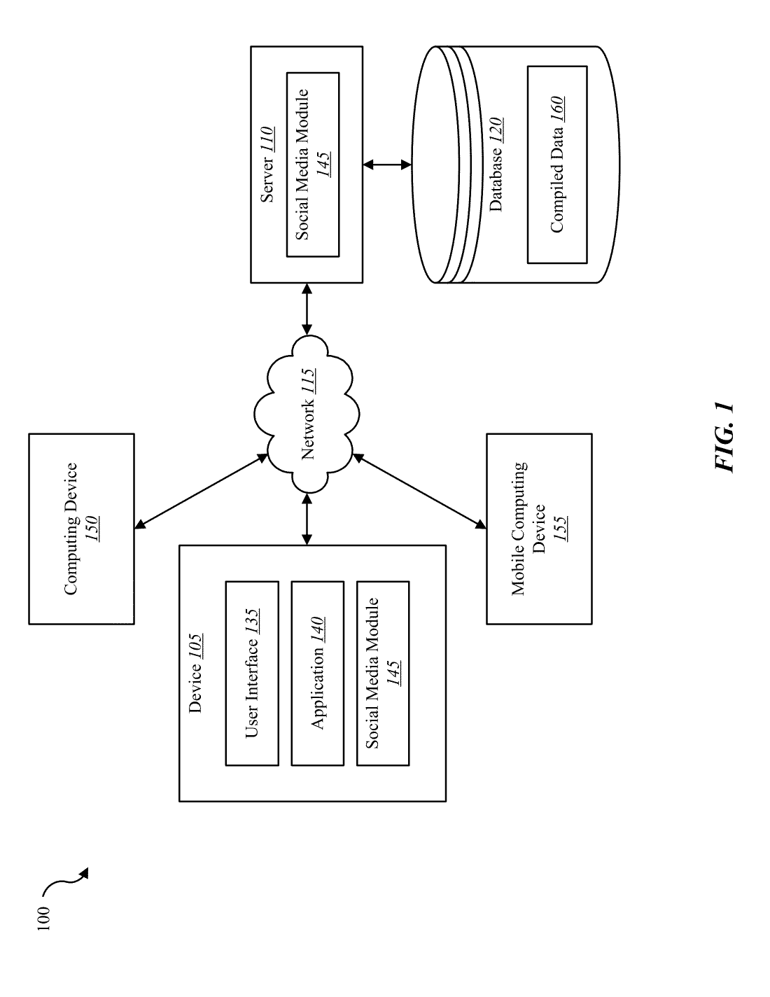

FIG. 1 is a block diagram illustrating one embodiment of an environment 100 in which the present systems and methods may be implemented. In some embodiments, the systems and methods described herein may be performed on a device (e.g., device 105). As depicted, the environment 100 may include a device 105, server 110, a computing device 150, a mobile computing device 155, and a network 115 that allows the device 105, the server 110, the computing device 150, and mobile computing device 155 to communicate with one another.

Examples of the device 105 may include any combination of mobile devices, smart phones, personal computing devices, computers, laptops, desktops, servers, media content set top boxes, etc. In some cases, as depicted, device 105 may be in communication with one or more other computing devices via network 115. Example of mobile computing device 155 may include a smartphone, tablet computing device, etc. Examples of computing device 150 may include any combination of a mobile computing device, a laptop, a desktop, a server, a media set top box, etc. Examples of server 110 may include any combination of a data server, a cloud server, a server associated with an automation service provider, proxy server, mail server, web server, application server, database server, communications server, file server, home server, mobile server, name server, etc.

In some configurations, the device 105 may include a user interface 135, application 140, and social media module 145. Although the components of the device 105 are depicted as being internal to the device 105, it is understood that one or more of the components may be external to the device 105 and connect to device 105 through wired and/or wireless connections. In some embodiments, application 140 may be installed on computing device 150 in order to allow a user to interface with a function of device 105, social media module 145, mobile computing device 155, and/or server 110.

In some embodiments, device 105 may communicate with server 110 via network 115. Examples of network 115 may include any combination of cloud networks, local area networks (LAN), wide area networks (WAN), virtual private networks (VPN), wireless networks (using 802.11, for example), cellular networks (using 3G and/or LTE, for example), etc. In some configurations, the network 115 may include the Internet. It is noted that in some embodiments, the device 105 may not include a social media module 145. For example, device 105 may include application 140 that allows device 105 to interface with mobile computing device 155 via social media module 145 located on another device such as computing device 150 and/or server 110. In some embodiments, device 105, mobile computing device 155, and server 110 may include a social media module 145 where at least a portion of the functions of social media module 145 are performed separately and/or concurrently on device 105, mobile computing device 155, and/or server 110. Likewise, in some embodiments, a user may access the functions of device 105 and/or mobile computing device 155 (directly or through device 105 via social media module 145) from computing device 150. For example, in some embodiments, computing device 150 includes a mobile application that interfaces with one or more functions of device 105, mobile computing device 155, social media module 145, and/or server 110.

In some embodiments, server 110 may be coupled to database 120. Database 120 may be internal or external to the server 110. In one example, device 105 may be coupled directly to database 120, database 120 being internal or external to device 105. Database 120 may include compiled data 160. For example, device 105 may access compiled data 160 in database 120 over network 115 via server 110. Compiled data 160 may include data that includes information specific to a user's connections on a social network and/or data randomly collected from one or more of the user's social media connections. In some cases, compiled data 160 may include data gathered regarding an organization. In some embodiments, compiled data 160 includes data associated with social media content, data provided by a moderator, and/or data gathered and sorted by category. For example, the compiled data 160 may include publically available data gathered from one or more social media contacts. Additionally, or alternatively, compiled data 160 may include data provided by a moderator such as an organization, corporation, merchant, advertiser, etc., that generates questions based on the provided data and delivers the questions to members of a private network or intranet. Additionally, or alternatively, compiled data 160 may include data gathered by social media module 145 and sorted into categories such as sports, politics, celebrities, organizations, businesses, etc.

Social media module 145 may enable a user to be tested regarding his or her social media connections. In some embodiments, social media module 145 may be configured to perform the systems and methods described herein in conjunction with user interface 135 and application 140. Further details regarding the social media module 145 are discussed below.

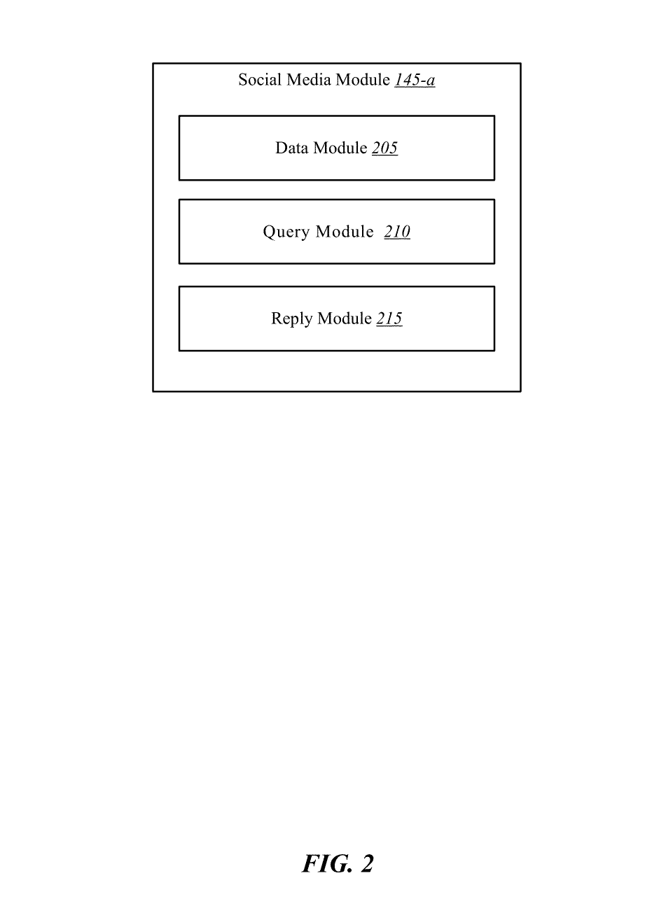

FIG. 2 is a block diagram illustrating one example of a social media module 145-a. Social media module 145-a may be one example of social media module 145 depicted in FIG. 1. As depicted, social media module 145-a may include a data module 205, a query module 210, and a reply module 215.

In one embodiment, data module 205 may compile data that includes information specific to a user's connections on a social network. Data module 205 may identify information specific to one of the user's social media connections (e.g., contact, friend, follower, user being followed, etc.). Data module 205 may correlate the received input with the data. In some embodiments, data module 205 may randomly collect data from one or more of the user's social media connections including posts, tweets, profile or “about” information, images, likes, preferences, etc. For example, a user may have one or more followers and/or friends. In some cases, the user may be following one or more other users. Accordingly, data module 205 may compile data from the user's one or more followers, friends, and/or other users the user is following. In some cases, data module 205 may use an algorithm to collect data from one or more of the user's connections.

The data module 205 may be granted access to the same information the user is able to access on the pages of the user's one or more followers, friends, and/or other users the user is following. Thus, data module 205 may crawl through the social media pages and posts of the user's followers, friends, and/or other users the user is following and gather textual information, links, photographs, etc. Accordingly, the compiled data may include at least one of an event, a status update, an image, a tweet, profile information, likes, preferences, etc.

In one embodiment, query module 210 may present a question. The question may be based at least in part on the compiled data. In some cases, the question may be presented via a user interface. For example, data module 205 may gather data about the user's friend such as a recent posted comment and/or posted image. The query module 210 may generate the question based on the data compiled. If the data includes a photograph, query module 210 may present the photograph and ask the question “Who is this?” In some cases, query module 210 may alter the photograph, cutting out or blocking certain portions of the photograph. For example, query module 210 may utilize facial recognition to recognize faces in the photo and then alter the photo so that at least a part of the face is blocked or cut out from view. Data module 205 may collect contextual information associated with the photo. For example, data module 205 may identify location information associated with the photo. Data module 205 may identify location information embedded in the photo metadata and/or may identify written description provided with the posting of the photo on the social media website. For example, the user that posted the photo may include a caption such as “My Hawaii Photos,” etc. Thus, upon acquiring location information with the compiled data, query module 210 may ask the question “This person recently went on a trip to Hawaii. Who is this person?” Query module 210 may or may not include a photo with the question. Query module 210 may include two or more answer choices with the question. For example, query module 210 may include the names of two or more of the user's friends, followers, and/or other users the user is following. The choices may include at least one correct answer. In some cases, the question may include True/False questions. The query module 210 may ask “Did John Smith recently go to Hawaii?” and include the choices “True” and “False.” The user interface may enable the user to select one of the choices.

In one embodiment, reply module 215 may receive the choice selected by the user and may responsd based on the choice selected. If the query module 210 determines that the user answered the question correctly, the reply module 215 may indicate that the question is answered correctly. If the query module 210 determines that the user answered the question incorrectly, the reply module 215 may indicate that the question is answered incorrectly. Thus, in some cases, reply module 215 may provide negative and/or positive feedback based at least in part on the input received from the user.

In some embodiments, the reply module 215 may provide a response to the user's selection based at least in part on receiving a user input or receiving no user input. In some embodiments, the query module 210 may post a countdown to the question. For example, query module 210 may ask the question and start a 30-second timer. If the user does not make a selection before the countdown timer lapses, then the query module 210 may mark the question as incorrect and reply module 215 may indicate that the question is marked as incorrect for failing to provide a selection before the countdown timer expired.

In some embodiments, the response provided by the reply module 215 may include at least one of a coupon, a voucher, a discount, a credit, and a product. For example, one or more questions generated by the query module 210 may be sponsored by an advertising entity. For instance, one or more questions may be sponsored by COCA-COLA®. Upon answering one or more questions correctly, reply module 215 may provide a coupon, a voucher, a discount, a credit, and/or a product in association with the sponsor of the questions, e.g., COCA-COLA®. In some cases, the user may receive the sponsored award upon satisfying a correct-answer threshold. For example, out of ten questions, the user may receive the sponsored award upon answering five or more questions correctly. Upon determining the threshold is satisfied, the reply module 215 may provide the user a coupon, a voucher, a discount, a credit, and/or a product from the sponsor of the questions.

In one embodiment, query module 210 may present a question to two or more users simultaneously, in real-time. For example, a question may be presented simultaneously to device 105 and computing device 150, or simultaneously to device 105 and mobile computing device 155, etc. In some cases, user-1 and user-2 may enter a competition to answer a set of questions. A winner between the users may be determined based on which user answers the most questions correctly. As indicated above, query module 210 may associate a countdown timer with a question. Thus, the winner between the two or more users may be determined by who answers the most questions correctly in the shortest amount of time. For example, reply module 215 may measure the response time of each user. Thus, the response provided by the reply module 215 may be based at least in part on the measured response time of the user. In some embodiments, reply module 215 may provide at least one response to each user in the group of social network users based at least in part on receiving a user input or receiving no user input from each user of the group of social network users. As an example, for a given question, query module 210 may record whether each user made a selection. Upon determining a selection was made, query module 210 may record the selection made by user-1 and/or user-2. Query module 210 may record the lapsed time before the selection was made and/or whether the selection was correct or incorrect. Thus, if query module 210 determines that both user-1 and user-2 each made the correct selection, and that user-2 took less time to answer the question than user-1, then user-2 may be designated the winner of that question. Query module 210 may tally points for each question answered correctly in the shortest amount of time. The user with the most points may win the competition. If the questions are sponsored and include a gift, the user that answers the most questions correctly in the shortest time may win the sponsored gift.

In some embodiments, the data module 205 may gather data regarding an organization, company, corporation, partnership, agency, firm, etc. For example, data module 205 may gather data about people in the organization, history of the organization, products of the organization, etc. The query module 210 may generate one or more questions based on the data gathered. The query module 210 may display one or more questions to an associate of the organization (e.g., employee, volunteer, contractor, fan, follower, etc.) based on the data gathered. Thus, the associate may learn more about the organization via the questions posed. For example, upon answering a question correctly, the reply module 215 may indicate the answer was correct and may provide one or more pieces of additional information regarding the substance of the information used to form the question. Likewise, upon identifying an incorrect choice, reply module 215 may indicate that the answer is incorrect and may provide additional information regarding the substance of the information used to form the question.

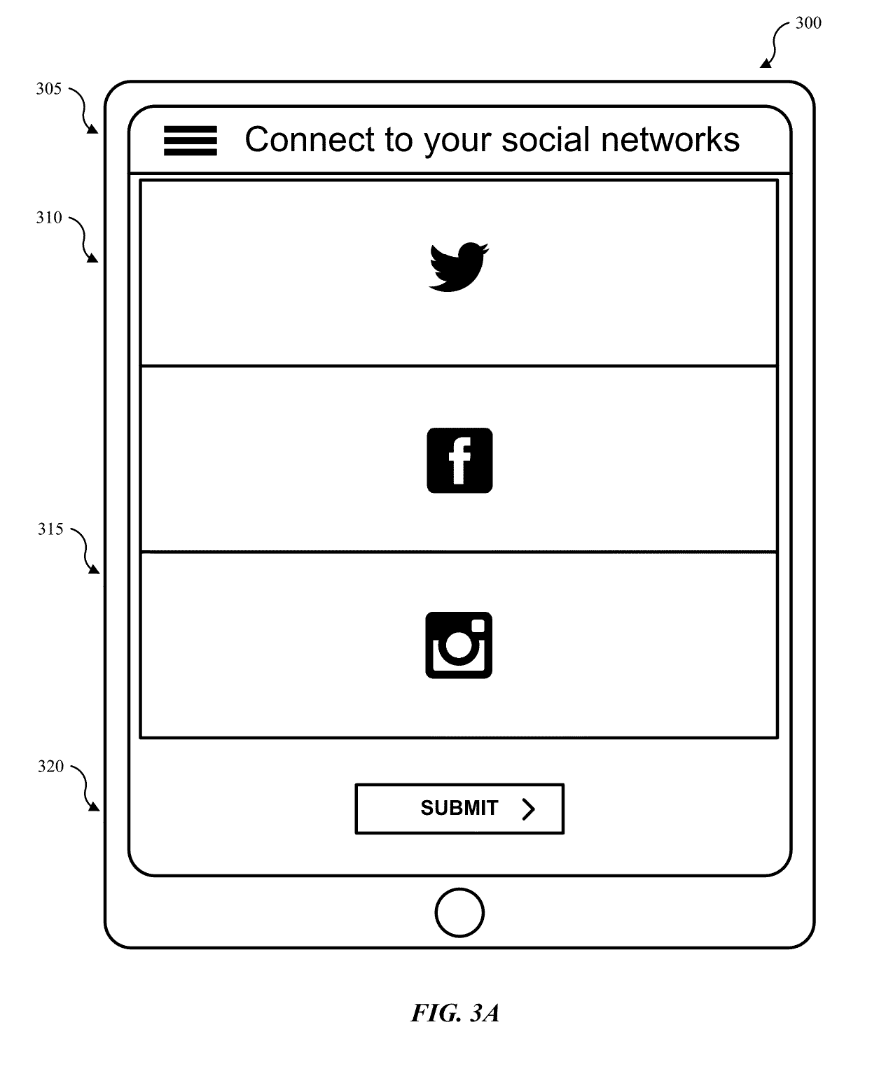

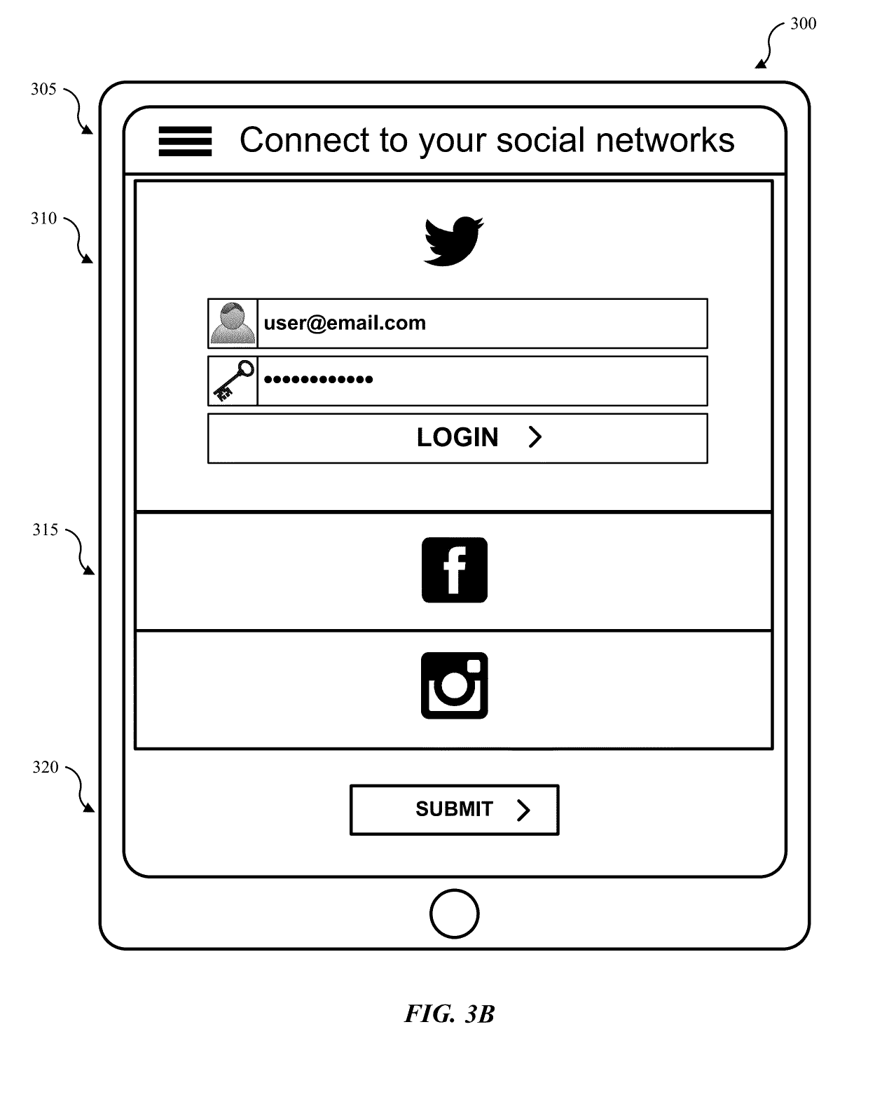

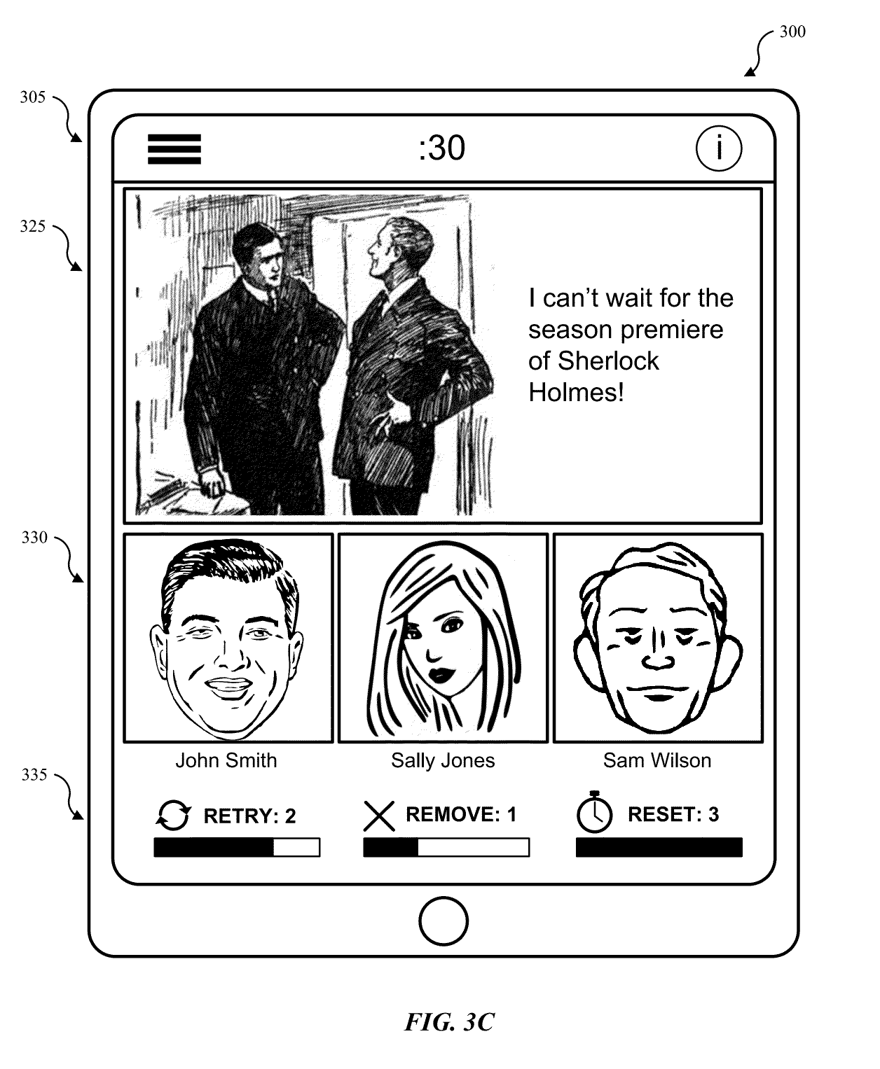

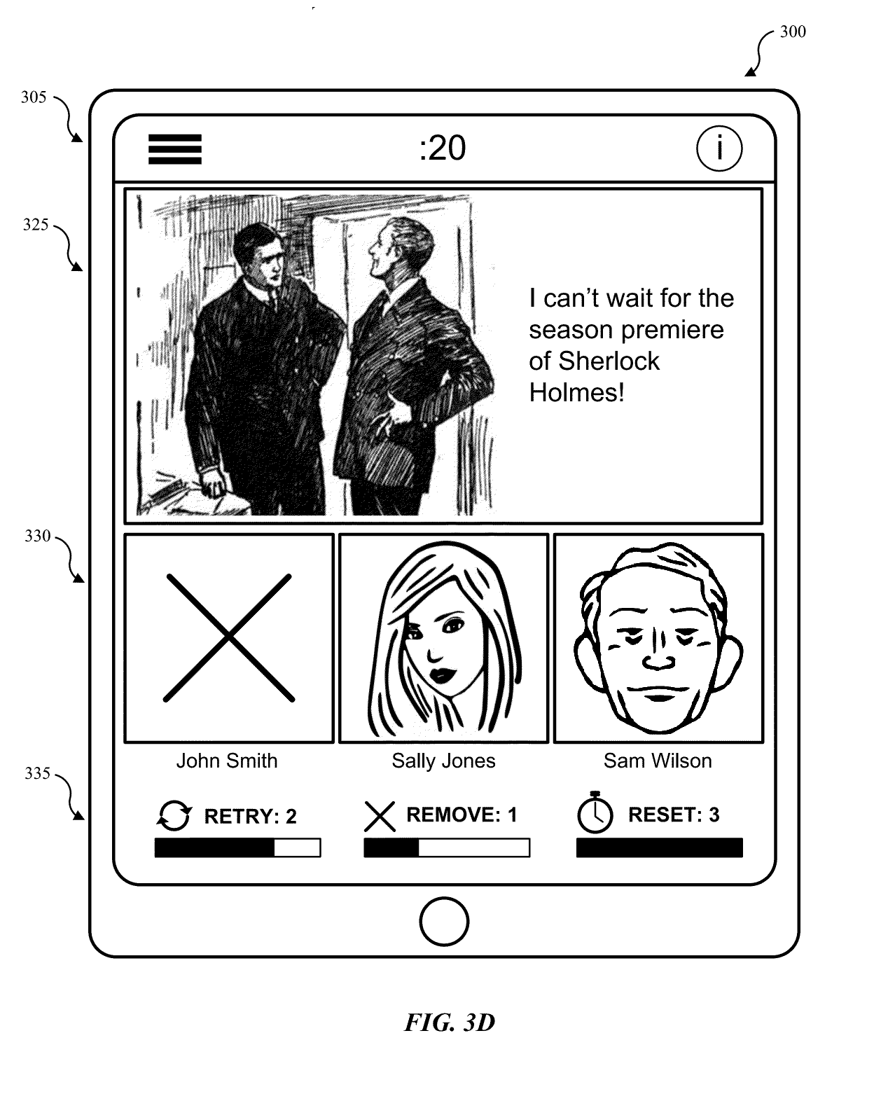

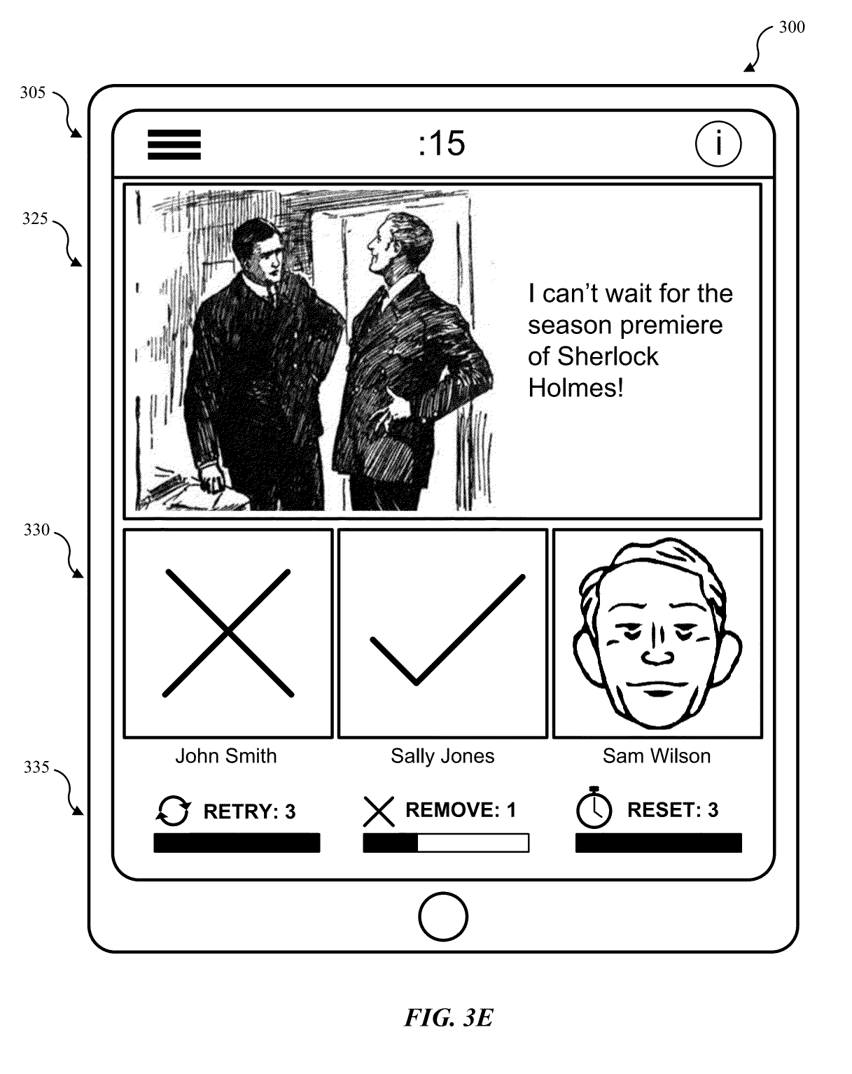

FIG. 3A is a block diagram illustrating one example of a mobile device 300 configured to interface with a social media platform. Mobile device 300 may include a user interface (e.g., user interface 135 of FIG. 1) enabled via a mobile application executing on mobile device 300. Although the user interface is depicted as accessible via a mobile device, it is understood that the user interface and functions described in relation to mobile device 300 may be implemented in a different type of computing device such as a personal computer, a laptop, a smart TV, etc. In some cases, the user interface may be accessible via an internet browser. As depicted, the user interface of mobile device 300 may include a title area 305, a social media networks section 310, and a submit button 320. The mobile device 300 and user interface may enable a user to play an interactive social-media-based game that tests the user's knowledge regarding his or her social media connections.

The title area 305 may include general information, as depicted, indicating that the user is presently enabled via the user interface to “Connect to your social networks.” The title area 305 may depict a menu button (i.e., the three horizontal bars to the left of the title area 305). Additionally, or alternatively, the title area 305 may provide further information regarding connecting to social media networks. The social media networks section 310 may depict the social media networks available for the user to enroll in the social-media-based game. Enrolling a social media network may include allowing the game access to the user's social media network connections, contacts, followers, connections followed by the user, as well as posts, uploaded images, tweets, about information, and the like from the user's social media account as well as the publicly available content from the user's social media contacts. As an example, the depicted social media networks section 310 may include options to enroll a TWITTER® account, a FACEBOOK® account, and/or an INSTAGRAM® account. Upon enrolling an account, the user may submit his or her selections using the submit button 320.

FIG. 3B is a block diagram illustrating another example of the mobile device 300. In some embodiments, when a user selects one of the available social media networks in the social media networks section 310, the user interface may display login options to authenticate the user's social media account. As depicted, when a user selects the TWITTER® option, the user interface may display text fields for a user name and a password, and a login button to authenticate the user's selected social media account. Upon authenticating the user, information from the user's account may be queried and stored for use in the social-media-based game. In some cases, the information from the user's enrolled social media account may be analyzed to determine whether the user has enough contacts to play the game. If it is determined that the user has enough contacts to play the game (e.g., via a predetermined threshold of minimum contacts), the user may be allowed to proceed with the enrolling and authentication process. As depicted, the other social media networks 315 may be displayed to enable the user to select one or more other social media networks to enroll in the game. Again, the user may submit the authentication and verification information via the submit button 320.

FIG. 3C is a block diagram illustrating one example of the mobile device 300. After authentication and verification are completed, the user may be enabled to play the social-media-based game based on information gathered from the user's enrolled social-media-networks. In some cases, the information used in the game may include data provided by a third party such as a business, corporation, organization, group, game moderator, etc. As depicted, the user interface of mobile device 300 may include the title area 305, a content area 325, a social media contact area 330, and a game tools section 335.

The title area 305 may depict timing information, an information button, and a menu button. The timing information may indicate an amount of time remaining for the user to make a selection in the game. As illustrated, the user may have 30 seconds to make the selection. In one embodiment, the depicted example of the social-media-based game may prompt the user to guess which social media contact generated the content displayed in the content area 325. The content may be retrieved from one of the social media contacts of the user playing the game. For example, the user may be FACEBOOK® “friends” with other social media users. These FACEBOOK® “friends” may include “John Smith,” “Sally Jones,” and “Sam Wilson.” Based on the social media contact information gathered during the authentication and verification steps described above, the game may randomly select a social media contact of the user. The game may then randomly select content from the randomly selected social media contact and display this randomly selected content in the content area 325. In some embodiments, the game may remove identifying information from the randomly selected post (e.g., user name, location information, etc.)

In some embodiments, the randomly selected content may include a post generated by a social media contact, an image uploaded by the social media contact, about information, etc. As depicted, the game may randomly select “Sally Jones” from the user's social media contacts. The game may then randomly select a post generated by “Sally Jones” on her social media account. The randomly selected content may include an image and a post regarding a television program. The game may also retrieve a profile picture of “Sally Jones” from her social media account. The game may then retrieve one or more other profile pics of other social media contacts of the user. Thus, the game may retrieve profile pictures of “John Smith” and “Sam Wilson.” Accordingly, the user may be prompted to guess which of his or her social media contacts displayed in the social media contact area 330 generated the content displayed in the content area 325. The game may provide additional selectable options to the user in the game tools section 335. The game tools section 335 may include the depicted options of “RETRY,” “REMOVE,” and “RESET,” among other possible options. The “RETRY” option may enable the user to retry upon making an incorrect selection. The “REMOVE” option may enable the user to remove a current question from a current game, where the current game includes two or more questions. Each of the depicted options in the game tools section 335 may be limited by a predetermined number of uses. As one example, each option may be used up to 3 times per game, as depicted. Thus, based on FIG. 3C, the “RETRY” option has been used 2 times leaving 1 more use, the “REMOVE” option 1 time leaving 2 more uses, and the “RESET” option 3 times leaving no more uses.

FIG. 3D is a block diagram illustrating one example of the mobile device 300. In one embodiment, the illustrated mobile device 300 of FIG. 3D indicates a user's selection regarding the content displayed in the content area 325. In some cases, the timing information in the title area 305 of the game may indicate the amount of time remaining to answer the current question and/or the amount of time that has elapsed since a user has received the current question of the game. As depicted, the timing information in the title area 305 indicates that 20 seconds remain before the question expires, indicating that 10 seconds have elapsed since the user started the current question if the original timer starts at 30 seconds. In some embodiments, the social media contact area 330 may indicate whether a user's selection is correct or incorrect. As depicted, the social media contact area 330 indicates that the user selected “John Smith” as a guess to who created the depicted content in the content area 325. The social media contact area 330 shows an “X” where the image of “John Smith” was previously displayed, indicating that the user's selection of “John Smith” is incorrect.

FIG. 3E is a block diagram illustrating one example of the mobile device 300. In one embodiment, the illustrated mobile device 300 of FIG. 3E indicates a user's re-selection regarding the content displayed in the content area 325. As depicted, the timing information in the title area 305 indicates that 15 seconds remain before the question expires, indicating that 15 seconds have elapsed since the user started the current question if the original timer starts at 30 seconds. As depicted, the social media contact area 330 indicates that the user's first selection of “John Smith” as a guess to who created the depicted content in the content area 325 is incorrect. Furthermore, the social media contact area 330 as depicted shows that the user has made a second guess as to who generated the content displayed in the content area 325. The user's second guess is “Sally Jones” and the correct guess is indicated with a checkmark. It is understood that other indications may be used to indicate incorrect/correct guesses. In some cases, the game tools section 335 may update based on a user's selection. In this case, upon selecting “Sally Jones” as a second guess, the “RETRY” option increases by 1. Thus, the game tools section 335 indicates that “RETRY” is now 3 leaving no more options to take a second guess on a question. In some cases, a user may purchase additional options in the game tools section 335, such as purchasing additional “RETRY,” “REMOVE”, “RESET,” and other options.

With reference to FIGS. 3A-3E, several types of game play may be made available to the user. For example, the user may be provided an option to play an “Own Network” game, a “Category” game, a “One-on-One” game, a “Group” game, a “Content” game, an “Advertising/Merchant” game, an “Organization/Corporation” game, and the like.

In “Own Network” play the game may use only the social media contacts of the user playing the game to populate the content and potential social media contacts that generated the content in a random fashion.

In “Category” play the user may be enabled to select from a list of predetermined categories, such as sports, politics, celebrities, organizations (e.g., corporations, businesses, groups, etc.). As one example, the user may select to play a “Category” game on a business. In some cases, selecting a business in “Category” play may enable further selection by industry type (e.g., technology, service, construction, etc.). The game may identify multiple businesses by industry type. The game may randomly select one of the identify businesses and randomly pick a post from the selected business. The game may acquire identifying information (e.g., business name, business logo, a photo associated with the business, etc.) from the selected business and display this information as one option and acquire similar identifying information from one or more other businesses that did not generate the randomly selected content being displayed.

In another example, a user may select to play a game with the celebrity category. The game may randomly select available content from a social media platform of the celebrity. For example, the game may select a post on Twitter that was posted by a particular celebrity. The Twitter post may be displayed to the user, along with pictures of three different celebrities. The user may select one of the three celebrities that the user believes submitted the post on Twitter. Multiple users may play against each other with the “categories” game, or a single user may play this type of game.

In “One-on-One” play the game may identify two players, a first player and a second player, where both players have been authenticated and verified by the system. The game may identify social media contacts shared by both the first and second users. The game may generate one or more questions based on a random selection of content from the shared contacts. The game may display that randomly selected content to both users and determine which user answers the most questions correctly. In some cases, the game may track the time each user takes to answer the questions. Thus, in the case of a tie, the user with the quickest time may be designated as the “winner.” In some embodiments, the users may play the game simultaneously such as on the same computing system or on different computers over an Internet connection. In some embodiments, the users may play the game asynchronously where each user plays the game when he or she decides to play. Thus, the first user may play one day and the second user may play later that same day or on another day.

In “Group” play, two or more users may connect to play the social-media-based game as a group. Unlike “One-to-One” play, in “Group” play the game may gather that content that is only generated by the members of the group. Thus, with players A, B, and C, the game may gather content only generated by players A, B, and C, but not content generated by the social media contacts of players A, B, and C. The game may randomly select a player from the group, randomly select content generated by the selected player on his or her enrolled social media account and display a form of this randomly selected content to the group. The game may display this content to the user and provide two or more potential generators of this content in the form of a profile picture, name, etc. Each member of the group may then be enabled to make a selection based on the provided information. In some cases, a group of users may play a “Category” game as a group.

In “Contest” play the game may collect information from the social media contacts of a user. The game may randomly select one of the user's social media contacts and then randomly select content generated by this randomly selected social media contact. The game may display this content to the user. In some embodiments, the game may cover or obfuscate at least a portion of the content from the user. For example, the game may select a profile picture of a social media contact of the user and display the selected profile picture to the user with a portion of the profile picture being obscured from view. In some cases, the game may divide the selected content into equal portions, such as dividing a profile picture into 4, 9, or 16 equal squares, for example. At least one of the squares may be visible, and one or more of the squares may be covered or obfuscated in some form. The game may then provide to the user two or more possible answer choices regarding the identity of the obscured content. In some embodiments, the game may provide an answer line or text field box and request that the user fill in the answer line or text field box with the correct name of the social media contact associated with the displayed content. In some cases, the game may provide one or more clues to the user. These clues may be available for purchase. Each clue may include content selected from the social media user that generated the displayed content. In some cases the content of the clues may include randomly selected information. For example, the user may be enabled to purchase a clue that includes a recent post, a recent photo, about information, etc. In some cases, the contest may be between two or more users. The first player may receive content from the first player's social media contacts and the second player may receive content from the second player's social media contacts. Thus, in some cases the content presented may differ from player to player. In some embodiments, the player with the most correct answers in the fastest time “wins” the contest. For example, the player that can get 10 correct answers in the fastest time may “win” the contest.

In “Advertising/Merchant” play the game may enable a merchant to advertise their products via a game. In some embodiments, the merchant may provide the content displayed during “Advertising/Merchant” play. For example, SUBWAY® may create a new sandwich. SUBWAY® may generate content for a game regarding its new sandwich. The content may include an image of the new sandwich with two or more answer choices, where one of the answer choices includes the correct answer associated with the new sandwich. For example, SUBWAY® may ask “Which of the following is the name of our new sandwich?” As another example, SUBWAY® may display a statement such as “Which of the images below is of our new sandwich?” and then provide two or more options that include an image of the new sandwich and one or more images of other sandwiches. In some cases, the system may deliver a sponsored gift to the user based on how the questions are answered (e.g., a coupon, a voucher, a discount, a credit, and/or product). For example, upon answering a pre-configured number of questions correct (e.g., 2 or more correct choices out of 3 questions, etc.), then the game may provide a coupon for a free sandwich to the user from SUBWAY®. In some embodiments, the game may indicate that the question is sponsored and may indicate the sponsor. In some cases, the user may be presented a list of sponsors and may be enabled to select their choice of sponsor. In one embodiment, the sponsor is selected from one or more organizations that the user is following via a social media service. For example, if the user is following PIZZA HUT®, COCA-COLA®, GOOGLE®, etc., the sponsor may be selected from these organizations that the user is presently following. In some cases, the sponsor may be selected from a pre-configured list, such as a list generated by the game and/or a list that the user creates in relation to user settings.

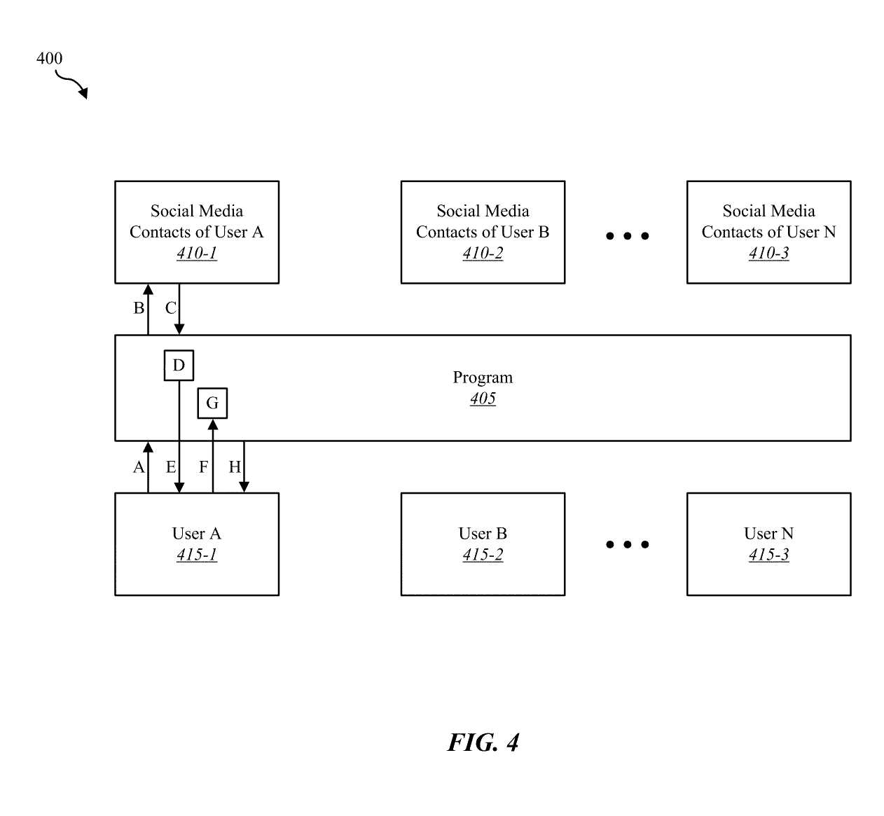

In “Organization/Corporation” play, the game may enable a moderator to generate content for one or more players. The moderator may generate content for a group of players where the players play simultaneously and/or at different times. As one example, the moderator may invite employees of a corporation to play a moderated “Organization/Corporation” game. The corporation may provide the content for each question. Thus, the moderator may deliver the corporation-provided content with answer choices to each participating player. Further information regarding the above-described game play options may be found in the description provided below regarding FIGS. 4-11.

FIG. 4 is a block diagram illustrating one example of an environment 400 for a social media platform. Environment 400 may include a user interface (e.g., user interface 135 of FIG. 1) enabled via an internet browser. The environment 400 may enable a user to be tested regarding his or her social media connections. As depicted, environment 400 may include a program 405, social media contacts of the various users 410-1 through 410-3, and the various users 415-1 through 415-3. Program 405 may be a software application. For example, program 405 may be executed on device 105, computing device 150, mobile computing device 155, and/or server 110. In some cases, the functions and actions described below may be performed in conjunction with social media module 145, application 140, and/or user interface 135. The social media contacts of User 410 may include one or more social media networks (e.g., FACEBOOK®, TWITTER®, PINTEREST®, GOOGLE+®, LINKED-IN®, INSTAGRAM®, etc.). Users 415 may include one or more users of a social media network.

As depicted, at A, user A 415-1 may send a request to program 405. At B, program 405 may search for social media content (e.g., a post, a tweet, a picture, etc.) within the social media contacts of user A 410-1. At C, program 405 identifies content from the social media contacts of user A 410-1 using predetermined criteria determined by the social media module 145. At D, program 405 modifies the content. In some cases, program 405 separates identifying information from the retrieved content. For example, program 405 may remove one or more names, location information, etc. In some cases, the retrieved content may include a photo. Program 405 may recognize a face in the retrieved photo and remove and/or obscure the face in the photo. At E, program 405 may deliver the modified content to user A 415-1 and include a question asking user A 415-1 to select a correct answer. For example, program 405 may ask “Which of these people made the following post?” In addition to the modified content (e.g., the modified/obfuscated post), program 405 may include information identifying the correct generator of the post as well as one or more other incorrect choices. In some cases, program 405 may display names of contacts of user A 415-1 (e.g., options A-D in FIG. 3). In some cases, program 405 may display a profile photograph of the person that generated the original content along with profile photographs of users that did not generate the content. Program 405 may enable user A 415-1 to select one of the options and determine whether a correct choice is made. At F, user A 415-1 makes a selection and the selection is communicated to program 405. At G, program A determines whether the selection is correct. At H, having determined whether the selection is correct, program 405 responds with a notification indicating whether the selection is correct. In some cases, program 405 may indicate timing information with the response (e.g., the time it took to answer the question, etc.).

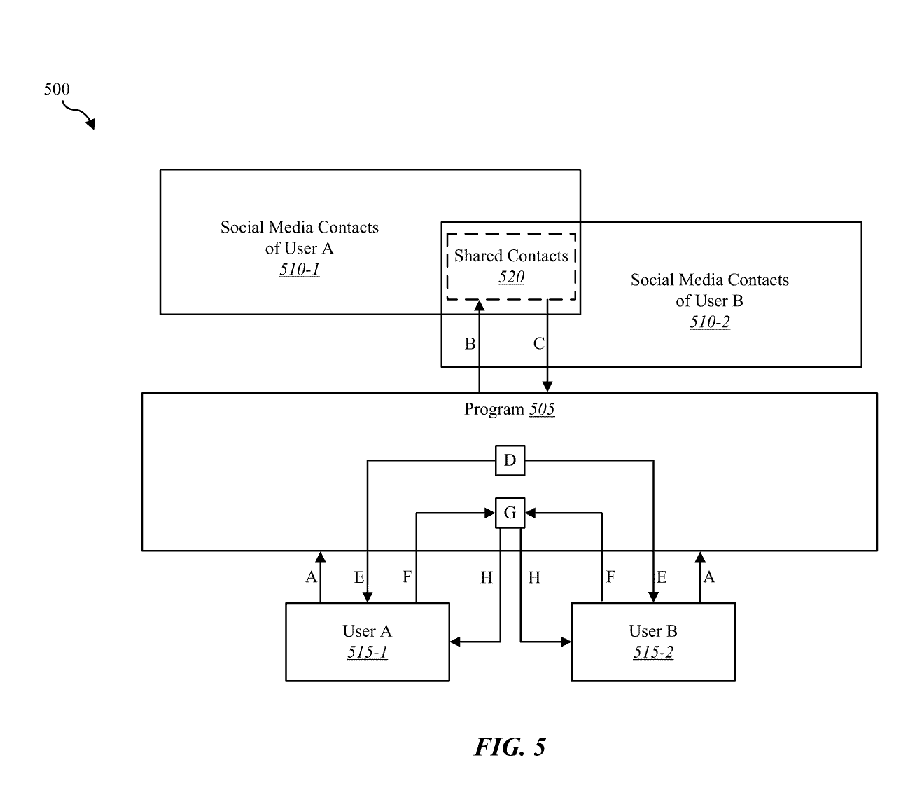

FIG. 5 is a block diagram illustrating one example of an environment 500 for a social media platform. Environment 500 may include a user interface (e.g., user interface 135 of FIG. 1) enabled via an internet browser. The environment 500 may enable a user to be tested regarding his or her social media connections. As depicted, environment 500 may include a program 505, social media contacts of user A 510-1 and the social media contacts of user B 510-2, user A 515-1 and user B 515-2, and the social media contacts shared between the users 520. Program 505 may be one example of program 405 in FIG. 4. Likewise, the social media contacts of user A 510 may be one example of contacts 410 of FIG. 4. In some cases, the functions and actions described below may be performed in conjunction with social media module 145, application 140, and/or user interface 135.

As depicted in FIG. 5, social network connections shared between the social network connections of user A 510-1 and the social network connections of user B 510-2 may be joined by the system as shared social media contacts 520. For example, program 505 may scan the connections of users A and B and determine whether the two users share social media contacts. As an example, both users A and B may be social network “friends” with “John Smith,” “Sally Jones,” and “Sam Wilson.” Thus, John Smith, Sally Jones, and Sam Wilson may make up part of the social media contacts 520 shared between users A and B. As with FIG. 4, a request may be sent to program 505. However, the request may be sent from both user A 515-1 as well as user B 515-2. Similar to the elements of FIG. 4, social media content may be retrieved. As depicted, content may be retrieved from more than one of the social media contacts of a user, and a question may be generated by program 505 based on the content retrieved. Program 505, at D, may alter the content and, at E, display the modified content to both user A and user B 515 with a correct answer and one or more incorrect answers. Program 505 may receive the respective answers at F, determine whether the answers are correct at G, and provide a response to each user at H.

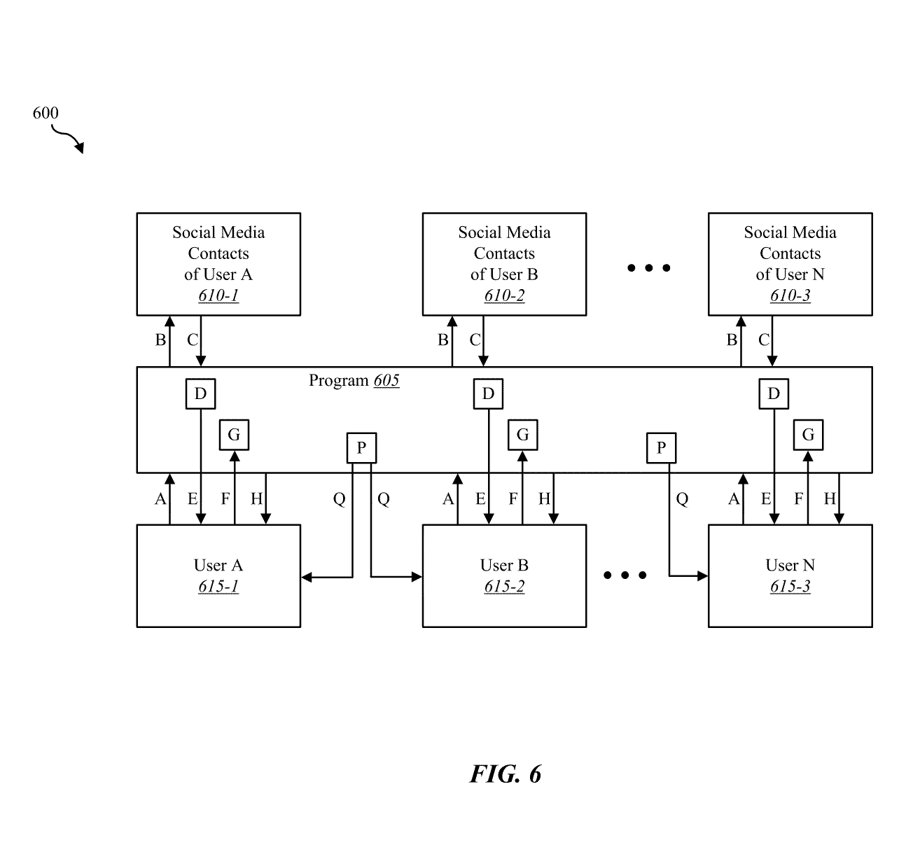

FIG. 6 is a block diagram illustrating one example of an environment 600 for a social media platform. Environment 600 may include a user interface (e.g., user interface 135 of FIG. 1) enabled via an internet browser. The environment 600 may enable a user to be tested regarding his or her social media connections. As depicted, environment 600 may include a program 605, the social media contacts of various users 610-1 through 610-3, and the various users 615-1 through 615-3. Program 605 may be one example of program 405 of FIG. 4 and/or program 505 of FIG. 5. Likewise, the social media contacts of user A 610 may be one example of contacts 410 of FIG. 4 and/or contacts 510 of FIG. 5. In some cases, the functions and actions described below may be performed in conjunction with social media module 145, application 140, and/or user interface 135.

Similar to FIGS. 4 and 5, program 605 may retrieve social media content, modify it, and display the modified content to one or more users (e.g., users 615 etc.). At P, program 605 may compare the answers and response times of each user and determine which user achieves the best score (e.g., the correct answer with the fastest response time). At Q, program 605 generates a notification indicating the winner of that round. Program 605 may send the notification to each user.

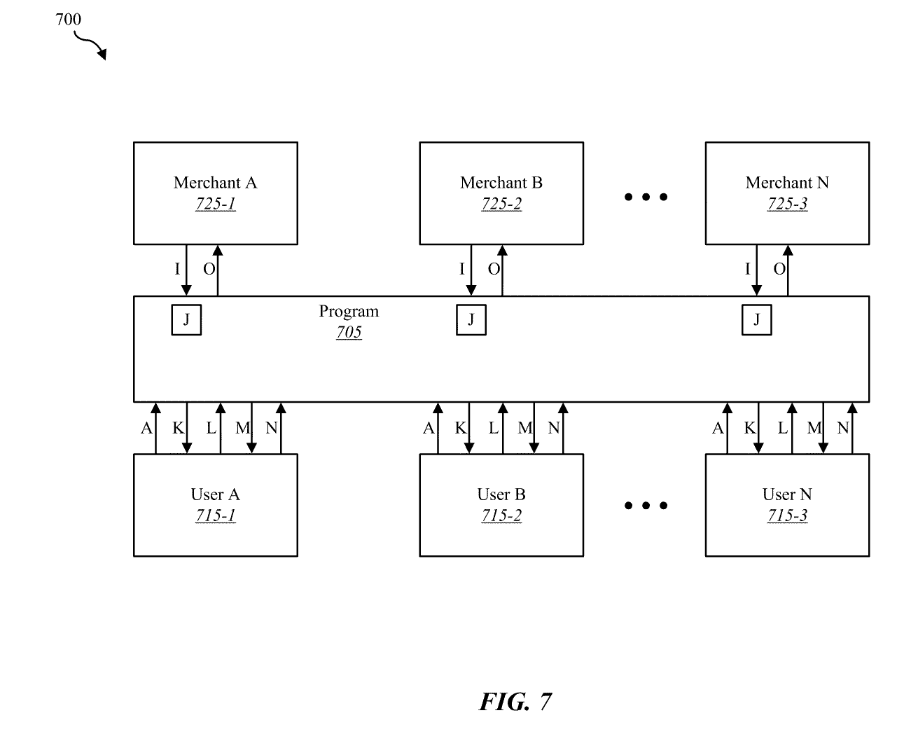

FIG. 7 is a block diagram illustrating one example of an environment 700 for a social media platform. Environment 700 may include a user interface (e.g., user interface 135 of FIG. 1) enabled via an internet browser. The environment 700 may enable a user to be tested regarding his or her knowledge of a merchant and/or a merchant's product. As depicted, environment 700 may include a program 705, multiple merchants 725-1 through 725-3, and multiple users 715-1 through 715-3. Program 705 may be one example of program 405 of FIG. 4, program 505 of FIG. 5, and/or program 605 of FIG. 6. Merchants 725 may include companies, clubs, organizations, agencies, government entities, etc. In some cases, the functions and actions described below may be performed in conjunction with social media module 145, application 140, and/or user interface 135.

As indicated, at A, each user may send a request to participate. At I, a merchant (e.g., merchants 725) may create and send merchant-related content. At J, program 705 may store the merchant-related content. The merchant-related content may be delivered by program 705 at a pre-determined time. At K, program 705 may recognize the pre-determined time and deliver the merchant-related content to appropriate users based on pre-configured criteria (e.g., indicated interest, geographic location, age, gender, nationality, and other demographic data, etc.). At L, users 715 may provide input in response to the delivery of the merchant-related content. For example, the merchant-related content may include a question and a user may provide an answer, etc. At M, program 705 provides a notification indicating whether an answer provided by a user is correct or not. At N, users 715 may provide another input. The other input may include a user indicating acceptance or rejection of a merchant offer. For example, a user may accept a coupon or purchase a product, etc. At O, program 705 may provide data to merchants 725 regarding user selection, user acceptance/rejection, user purchase information, etc. In some cases, program 705 may subtract a fee for any transaction occurring in relation to a user selection at N.

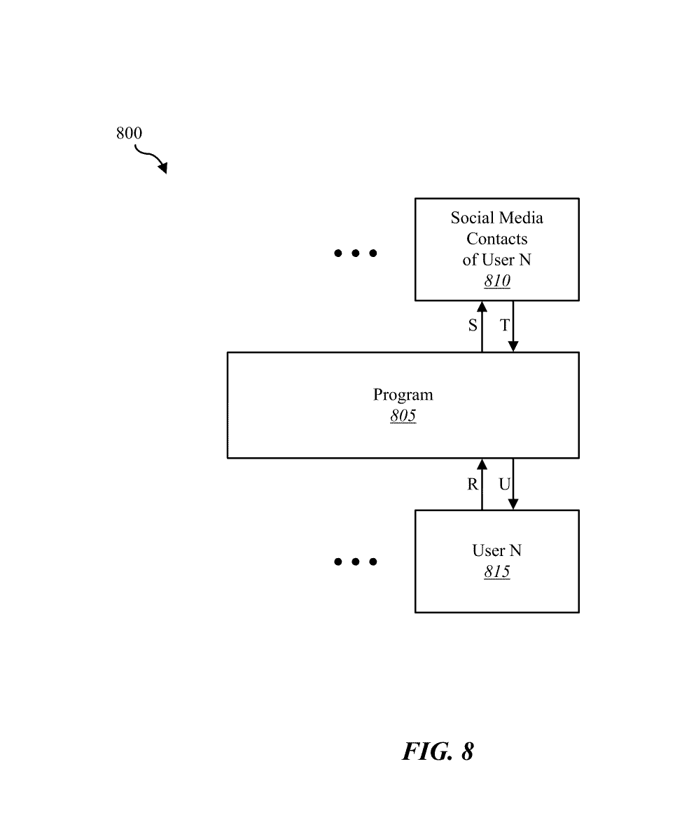

FIG. 8 is a block diagram illustrating one example of an environment 800 for a social media platform. Environment 800 may include a user interface (e.g., user interface 135 of FIG. 1) enabled via an internet browser. The environment 800 may enable a user to be tested regarding his or her social media connections. As depicted, environment 800 may include a program 805, the social media contacts of at least one user N 810, and at least one user N 815. Program 805 may be one example of program 405 of FIG. 4, program 505 of FIG. 5, program 605 of FIG. 6, and/or program 705 of FIG. 7. Likewise, the social media contacts of user N 810 may be one example of the social media contacts of user A 410 of FIG. 4, the social media contacts of user A 510 of FIG. 5, the social media contacts of user A 610 of FIG. 6, and/or the social media contacts of user A 710 of FIG. 7. In some cases, the functions and actions described below may be performed in conjunction with social media module 145, application 140, and/or user interface 135.

As depicted, at R, a user 815 may provide program 805 with user credentials. The providing of user credentials may be in conjunction with a user request to participate in a predetermined activity with program 805 (e.g., answer questions generated by program 805, etc.). At S, program 805 may query the social media contacts of user N 810 to authenticate user 815. In some cases, at S, program 805 may request data quantity information from the social media contacts of user N 810. An initial data download may be requested in relation to S. At T, the social media contacts of user N 810 may respond regarding the authentication request. If user authenticates, the social media contacts of user N 810 may return quantity information and the initial data download. At U, program 805 may determine whether user 815 qualifies to participate in the predetermined activity and provide an affirmative or negative response. For example, program 805 may request data quantity information from user 815 in the form of social network contacts. Program 805 may review the provided social network contacts and determine whether the volume of contacts satisfies a contacts threshold. For instance, program 805 may establish a contact threshold of 100 contacts. If user 815 only has 10 contacts, program 805 may block user 815 from participating for lack of sufficient contacts. On the other hand, if user 815 has 150 contacts, program 805 may determine that user 815 has sufficient contacts to participate.

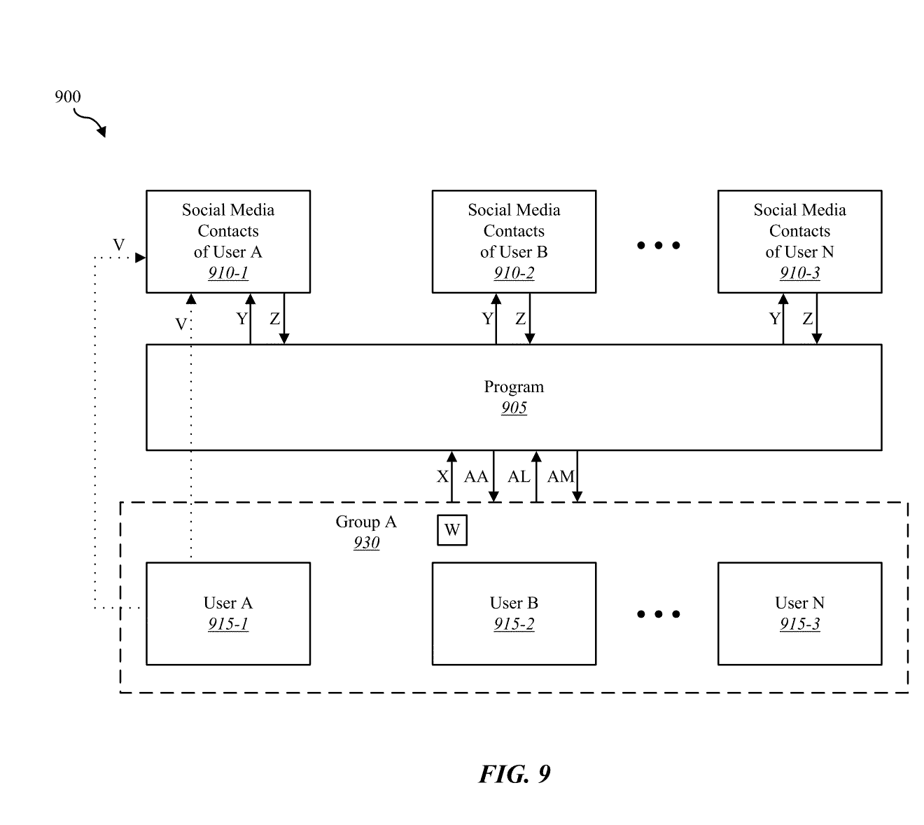

FIG. 9 is a block diagram illustrating one example of an environment 900 for a social media platform. Environment 900 may include a user interface (e.g., user interface 135 of FIG. 1) enabled via an internet browser. In one embodiment, the environment 900 may enable a user to be tested regarding his or her social media connections. In some embodiments, environment 900 may enable a user to be tested on information gathered from participants of a game. For example, users A, B, and C may agree to play a game with each other. The information used in the game may come from the social network accounts of users A, B, and C such as posts made or images uploaded by users A, B, or C. In some embodiments, the content gather may exclude content from the social media network connections of users A, B, and C, and only gather information generated by users A, B, and C.

As depicted, environment 900 may include a program 905, the social media contacts of various user 910-1 through 910-3, the various users 915-1 through 915-3, and group A 930 (e.g., a group of users). Program 905 may be one example of program 405 of FIG. 4, program 505 of FIG. 5, program 605 of FIG. 6, program 705 of FIG. 7, and/or program 805 of FIG. 8. Likewise, the social media contacts of user A 910 may be one example of the social media contacts of user A 410 of FIG. 4, the social media contacts of user A 510 of FIG. 5, the social media contacts of user A 610 of FIG. 6, the social media contacts of user A 710 of FIG. 7, and/or the social media contacts of user A 810 of FIG. 8. In some cases, the functions and actions described below may be performed in conjunction with social media module 145, application 140, and/or user interface 135.

As depicted, at V, user A 915-1 sends a challenge to one of the social media contacts of user A 910-1 to challenge one or more other members of user A's network to a group contest. The challenge, as depicted, may be sent directly to one or more of the social media contacts of user A 910-1 and/or via program 905. At W, the selected users may accept or reject the group challenge request. Program 905 gathers the accepting users into group A 930. At X, group A 930 selects to start the contest. At Y, program 905 requests social media content from posts created in each user's networks. For example, the content may be limited, by program 905, to content generated only by the users in group A 930. In some cases, the content may be limited, by program 905, to content generated by overlapping contacts between users of group A 930. For example, if John Smith is identified as a contact/friend of each user in group A 930, then content from John Smith may be used to generate one or more questions in the contest, whether or not John Smith is in group A 930. At Z, at least one of the social media contacts of user A 910 may provide the requested content. At AA, program 905 delivers a question to each of the users in group A 930 based on a modification of the content provided by at least one of the social media contacts of user A 910 at Z. At AL, each user provides an answer in response to the question. A non-response may be automatically marked as an incorrect response. The question may include a countdown timer. If time expires before a user provides an answer, that user may be given an incorrect. At AM, program 905 provides the results of each user's answer, including correct/incorrect answers, timing information, etc.

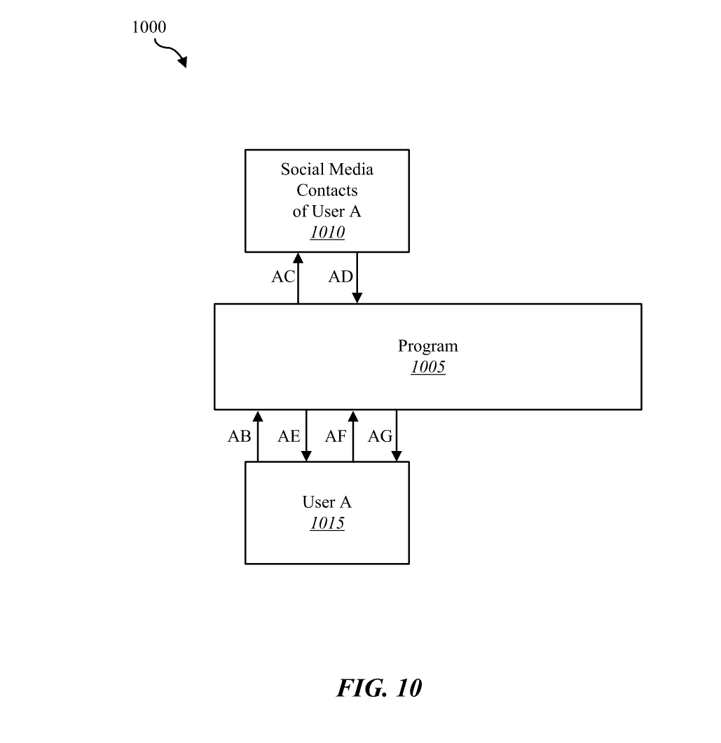

FIG. 10 is a block diagram illustrating one example of an environment 1000 for a social media platform. Environment 1000 may include a user interface (e.g., user interface 135 of FIG. 1) enabled via an internet browser. The environment 1000 may enable a user to be tested regarding his or her social media connections. As depicted, environment 1000 may include a program 1005, the social media contacts of user A 1010, and a user 1015. Program 1005 may be one example of program 405 of FIG. 4, program 505 of FIG. 5, program 605 of FIG. 6, program 705 of FIG. 7, program 805 of FIG. 8, and/or program 905 of FIG. 9. Likewise, the social media contacts of user A 1010 may be one example of the social media contacts of user A 410 of FIG. 4, the social media contacts of user A 510 of FIG. 5, the social media contacts of user A 610 of FIG. 6, the social media contacts of user A 710 of FIG. 7, the social media contacts of user A 810 of FIG. 8, and/or the social media contacts of user A 910 of FIG. 9. In some cases, the functions and actions described below may be performed in conjunction with social media module 145, application 140, and/or user interface 135.

As depicted, at AB, user A 1015 may elect to play a categories contest. At AC, program 1005 may request all available data from entity A's network 1135 for data related to one or more categories specified by user A 1015 (e.g., sports, politics, celebrities, organizations, corporations, businesses, groups, etc.). At AD, the network 1135 returns the requested data. At AE, program 1005 converts the received data into a post, and delivers the post to user A 1015. At AF, user A 1015 provides one or more inputs in response to the post. At AG, program 1005 responds with results based on user selections provided in AF.

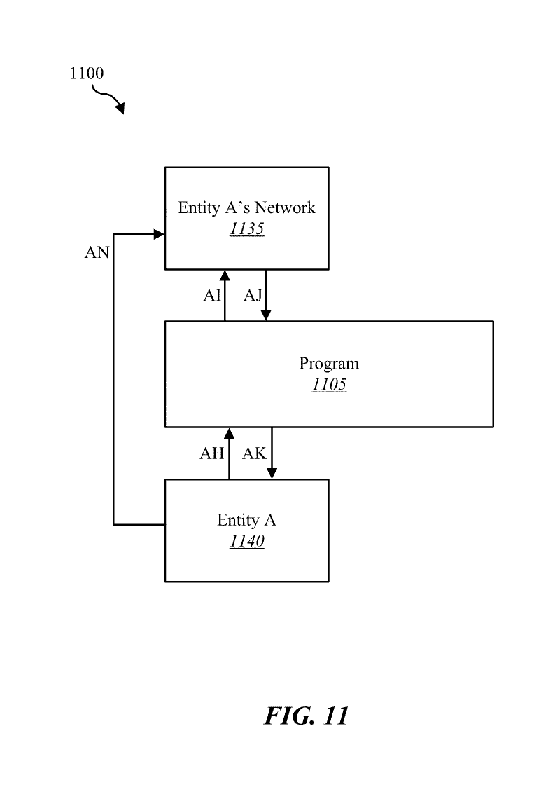

FIG. 11 is a block diagram illustrating one example of an environment 1100 for a social media platform. Environment 1100 may include a user interface (e.g., user interface 135 of FIG. 1) enabled via an internet browser. The environment 1100 may enable a user to be tested regarding his or her knowledge of content delivered by an entity such as entity A. For example, entity A may generate content such as images of products and generate questions based on the images of products, etc. As depicted, environment 1100 may include a program 1105, an entity's A network 1135, and entity A 1140. Entity A's network 1135 may include social media contacts of entity A. Additionally, or alternatively, entity A's network 1135 may include contacts other than social media contacts. For example, in some embodiments, entity A's network 1135 may include an intranet or internal network of associates, colleagues, employees, clients, vendors, customers, etc.

Program 1105 may be one example of program 405 of FIG. 4, program 505 of FIG. 5, program 605 of FIG. 6, program 705 of FIG. 7, program 805 of FIG. 8, program 905 of FIG. 9, and/or program 1005 of FIG. 10. Likewise, entity A's network 1135 may be one example of contacts 410 of FIG. 4, contacts 510 of FIG. 5, contacts 610 of FIG. 6, contacts 710 of FIG. 7, contacts 810 of FIG. 8, contacts 910 of FIG. 9, and/or contacts 1010 of FIG. 10. In some cases, the functions and actions described below may be performed in conjunction with social media module 145, application 140, and/or user interface 135.

As depicted, at AH, entity A 1140 may sign up for a service. Entity A 1140 may provide content to program 1105. For example, entity A may generate content for a contest. For instance, a company may generate questions and provide the questions to employees such as training questions, promotional offers, etc. At AN, entity A 1140 may invite specific contacts into entity A's network 1135 to participate in a contest. At AI, program 1105 may deliver the content created by entity A 1140 to participating members of entity A's network 1135. At AJ, each participating member of entity A's network 1135 may provide a response to the content created by entity A 1140 via program 1105. At AK, program 1105 may provide information to entity A 1140 based on the responses provided in AJ.

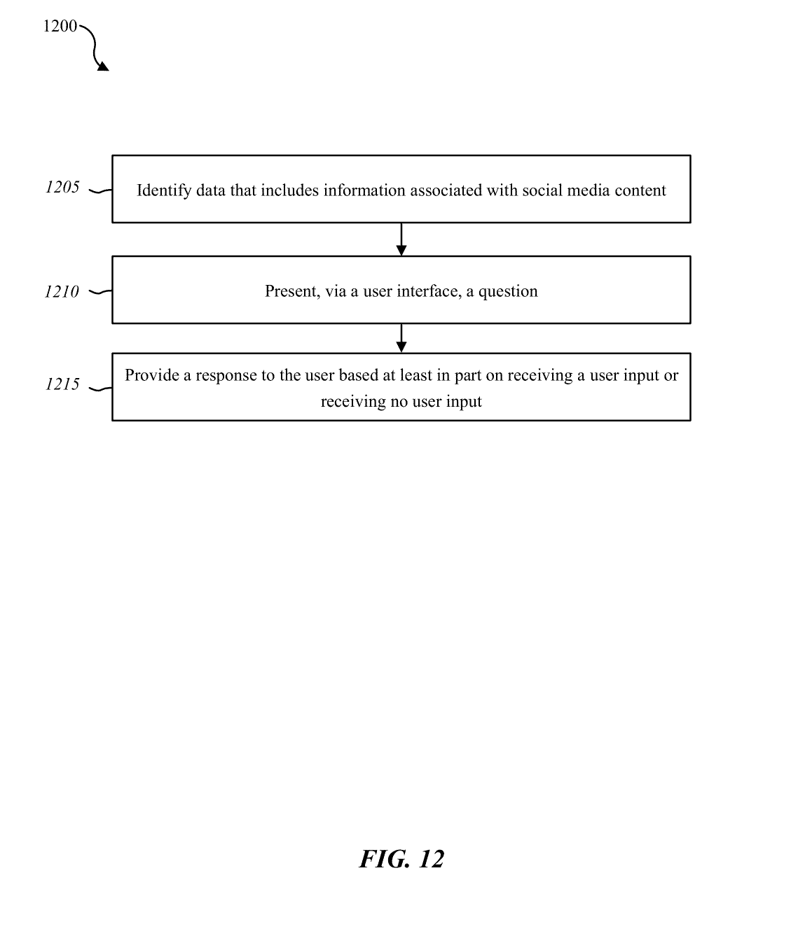

FIG. 12 is a flow diagram illustrating one embodiment of a method 1200 for a social media platform. In some configurations, the method 1200 may be implemented by the social media module 145 illustrated in FIGS. 1 and/or 2. In some configurations, the method 1200 may be implemented in conjunction with the application 140 and/or the user interface 135 illustrated in FIG. 1.

At block 1205, data that includes information associated with social media content may be identified. At block 1210, a question may be presented via a user interface. The question may be based at least in part on one or more of the identified data, data provided by a moderator, or data gathered and sorted by category. At block 1215, a response to the user may be provided based at least in part on receiving a user input or receiving no user input.

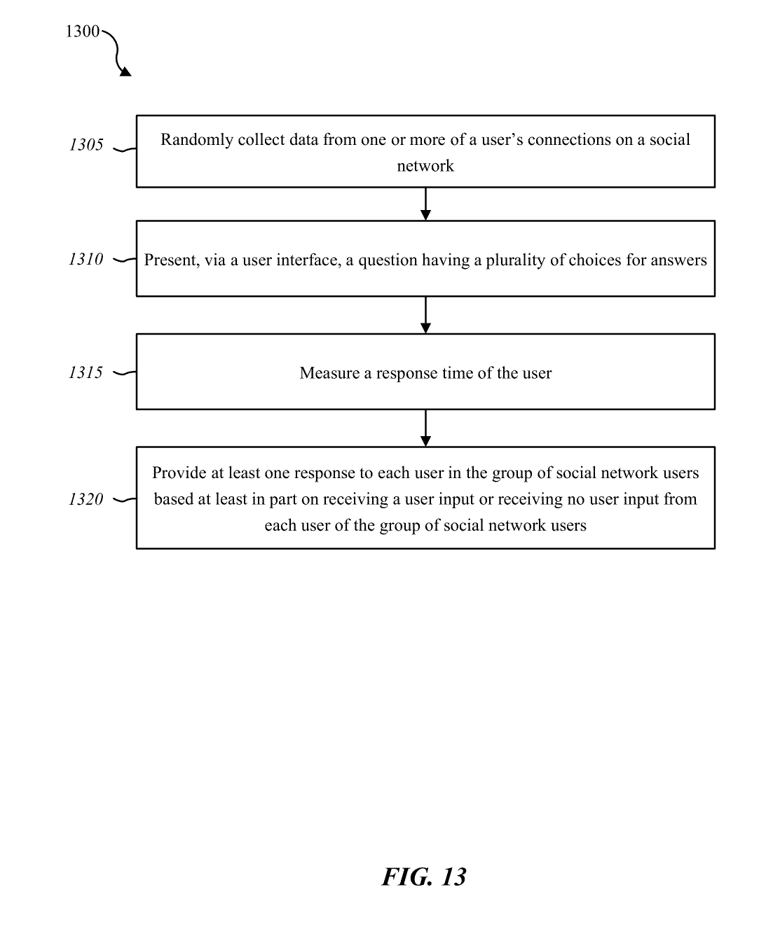

FIG. 13 is a flow diagram illustrating one embodiment of a method 1300 for a social media platform. In some configurations, the method 1300 may be implemented by the social media module 145 illustrated in FIG. 1 or 2. In some configurations, the method 1300 may be implemented in conjunction with the application 140 and/or the user interface 135 illustrated in FIG. 1.

At block 1305, data that includes information from one or more of a user's connections on a social network may be randomly collected. The data may include at least one of an event, a status update, an image, and a photograph. At block 1310, a question having a plurality of choices for answers may be presented to two or more users. In some cases, the question may be presented to the users simultaneously and/or at different times. The question may be based at least in part on the randomly collected data. At block 1315, a response time of the user may be measured. At block 1320, a response to the user may be provided based at least in part on receiving a user input or receiving no user input. The response may include at least one of a coupon, a voucher, a discount, a credit, and a product. In some cases, providing the response may be based at least in part on a measured response time of each user.

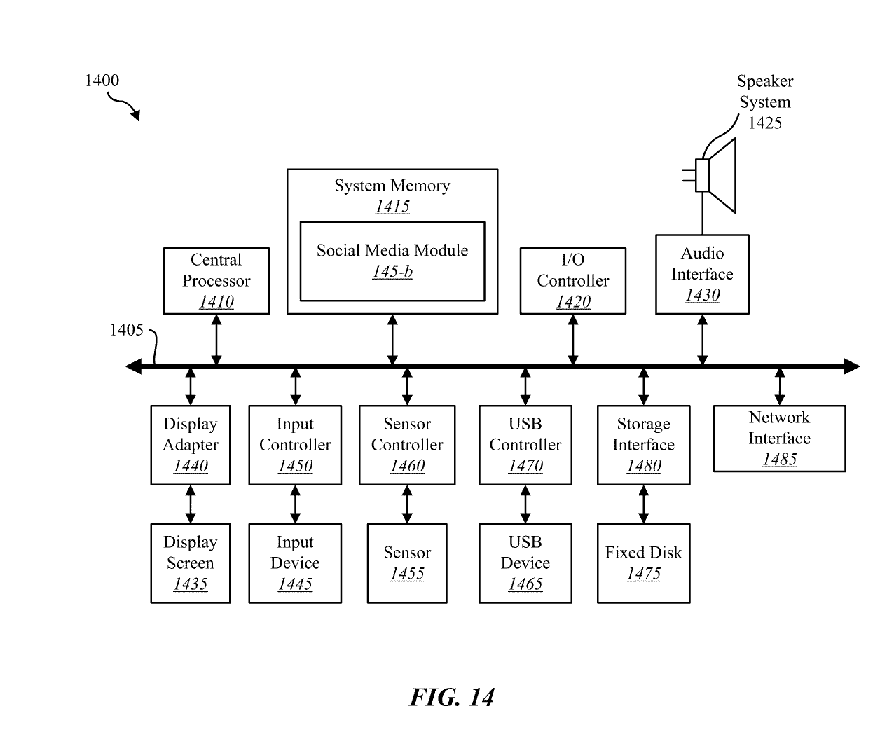

FIG. 14 depicts a block diagram of a computing device 1400 suitable for implementing the present systems and methods. The device 1400 may be an example of device 105, computing device 150, mobile computing device 155, and/or server 110 illustrated in FIG. 1. In one configuration, computing device 1400 includes a bus 1405 which interconnects major subsystems of computing device 1400, such as a central processor 1410, a system memory 1415 (typically RAM, but which may also include ROM, flash RAM, or the like), an input/output controller 1420, an external audio device, such as a speaker system 1425 via an audio output interface 1430, an external device, such as a display screen 1435 via display adapter 1440, an input device 1445 (e.g., remote control device interfaced with an input controller 1450), multiple USB devices 1465 (interfaced with a USB controller 1470), and a storage interface 1480. Also included are at least one sensor 1455 connected to bus 1405 through a sensor controller 1460 and a network interface 1485 (coupled directly to bus 1405).

Bus 1405 allows data communication between central processor 1410 and system memory 1415, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components or devices. For example, the social media module 145-b to implement the present systems and methods may be stored within the system memory 1415. Applications (e.g., application 140) resident with computing device 1400 are generally stored on and accessed via a non-transitory computer readable medium, such as a hard disk drive (e.g., fixed disk 1475) or other storage medium. Additionally, applications can be in the form of electronic signals modulated in accordance with the application and data communication technology when accessed via interface 1485.

Storage interface 1480, as with the other storage interfaces of computing device 1400, can connect to a standard computer readable medium for storage and/or retrieval of information, such as a fixed disk drive 1475. Fixed disk drive 1475 may be a part of computing device 1400 or may be separate and accessed through other interface systems. Network interface 1485 may provide a direct connection to a remote server via a direct network link to the Internet via a POP (point of presence). Network interface 1485 may provide such connection using wireless techniques, including digital cellular telephone connection, Cellular Digital Packet Data (CDPD) connection, digital satellite data connection, or the like. In some embodiments, one or more sensors (e.g., motion sensor, smoke sensor, glass break sensor, door sensor, window sensor, carbon monoxide sensor, and the like) connect to computing device 1400 wirelessly via network interface 1485.

Many other devices or subsystems (not shown) may be connected in a similar manner (e.g., entertainment system, computing device, remote cameras, wireless key fob, wall mounted user interface device, cell radio module, battery, alarm siren, door lock, lighting system, thermostat, home appliance monitor, utility equipment monitor, and so on). Conversely, all of the devices shown in FIG. 14 need not be present to practice the present systems and methods. The devices and subsystems can be interconnected in different ways from that shown in FIG. 14. The aspect of some operations of a system such as that shown in FIG. 14 are readily known in the art and are not discussed in detail in this application. Code to implement the present disclosure can be stored in a non-transitory computer-readable medium such as one or more of system memory 1415 or fixed disk 1475. The operating system provided on computing device 1400 may be iOS®, ANDROID®, MS-DOS®, MS-WINDOWS®, OS/2®, UNIX®, LINUX®, or another known operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present systems and methods may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Furthermore, while various embodiments have been described and/or illustrated herein in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.” In addition, the term “based on” as used in the specification and the claims is to be construed as meaning “based at least upon.”

What is claimed is:

1. A method for a social media platform comprising:
identifying data that includes information associated with social media content;
presenting, via a user interface, a question based at least in part on one or more of the identified data, data provided by a moderator, and data gathered and sorted by category; and
providing a response to the user based at least in part on receiving a user input or receiving no user input.

2. The method of claim 1, wherein identifying the data comprises randomly collecting data from one or more of the user's connections.

3. The method of claim 1, wherein identifying the data comprises using an algorithm to collect data from one or more of the user's connections.

4. The method of claim 1, wherein the data includes identifying information specific to one of the user's social media connections.

5. The method of claim 1, wherein the question comprises a plurality of choices, the plurality of choices including one correct answer.

6. The method of claim 1, comprising:
correlating the received input with the data.

7. The method of claim 1, wherein providing the response comprises providing feedback based at least in part on the received input.

8. The method of claim 1, wherein providing the response is based at least in part on a measured response time of the user.

9. The method of claim 1, wherein the data include at least one of an event, a status update, an image, and a photograph.

10. The method of claim 1, wherein the response includes at least one of a coupon, a voucher, a discount, a credit, and a product.

11. The method of claim 1, wherein presenting the question includes presenting the question to a group of two or more social network users.

12. The method of claim 11, comprising:
providing at least one response to each user in the group of social network users based at least in part on receiving a user input or receiving no user input from each user of the group of social network users.

13. A computing device configured for a social media platform, comprising:
a processor;
memory in electronic communication with the processor, wherein the memory stores computer executable instructions that when executed by the processor cause the processor to perform the steps of:
identifying data that includes information associated with social media content;
presenting, via a user interface, a question based at least in part on one or more of the identified data, data provided by a moderator, and data gathered and sorted by category; and
providing a response to the user based at least in part on receiving a user input or receiving no user input.

14. The computing device of claim 13, wherein identifying the data comprises randomly collecting data from one or more of the user's connections.

15. The computing device of claim 13, wherein identifying the data comprises using an algorithm to collect data from one or more of the user's connections.

16. The computing device of claim 13, wherein the data includes identifying information specific to one of the user's social media connections.

17. The computing device of claim 13, wherein the question comprises a plurality of choices, the plurality of choices including one correct answer.

18. The computing device of claim 13, wherein the instructions executed by the processor cause the processor to perform the steps of:
presenting the question to two or more users; and
providing at least one response to each user in the group of social network users based at least in part on receiving a user input or receiving no user input from each user of the group of social networks.

19. A non-transitory computer-readable storage medium storing computer executable instructions that when executed by a processor cause the processor to perform the steps of:
identifying data that includes information associated with social media content;
presenting, via a user interface, a question based at least in part on one or more of the identified data, data provided by a moderator, and data gathered and sorted by category; and
providing a response to the user based at least in part on receiving a user input or receiving no user input.

20. The computer-program product of claim 19, wherein identifying the data comprises randomly collecting data from one or more of the user's connections.
